(19) United States
(12) Patent Application Publication
(10) Pub. No.: US 2006/0237936 A1
(43) Pub. Date: Oct. 26, 2006

(54) Anti-slip surface for skateboards

(76) Inventor: Chorng-Jiang Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/455,837

(22) Filed: Jun. 20, 2006

Related U.S. Application Data
(62) Division of application No. 10/869,954, filed on Jun. 18, 2004.

(51) Int. Cl. B62M 1/00

(52) U.S. Cl. 280/87.042

(57) ABSTRACT

A skateboard includes at least one layer of board member and a plurality of anti-slip portions are defined in an upper and bottom surfaces of the at least one layer of board member. The anti-slip portions are located close to a periphery of the at least one layer of board member and each anti-slip portion includes ridges and grooves so that the users can easily grab the skateboard.

### FIELD OF THE INVENTION

The present invention relates to a skateboard that has anti-slip portions such that the user may hold the skateboard easily and firmly.

### BACKGROUND OF THE INVENTION

A conventional skateboard generally includes a plurality of layers laminated with each other to form the board member. Although these layers can be made by different types of materials, the adhering area is limited and the structural strength of the board member is not strong enough. Usually, the board has two opposite surfaces which do not involve any anti-slip feature and this is not convenient for thee users.

Another skateboard includes two layers of wood layers and a metal intermediate layer which is sandwiched between the two wood layers. However, the wood layers and the metal layers are two different types of material and may not suitable to be adhered with each other. Besides, the wood layers and the metal layer have their individual physical features and cracks could be found at the joint surfaces after being used for a period of time. The board member has to be flat for convenience of matching the two different types of material and this flat board member is disadvantageous for being held by the users.

Yet another skateboard includes several elongate tubes adhered in the board member and this structure is difficult to assemble and the tubes tend to be separated from the material to which they are adhered due to the change of temperature.

U.S. Pat. No. 4,234,204 discloses a skateboard as shown in FIGS. 11, 12, the board member 90 includes several ridges 91 extending from a surface of the board member 90 and the ridges 91 have smooth outer surface so that they cannot not provide proper friction for the user to hold the board member 90. U.S. Pat. No. 5,924,718 discloses a skateboard as shown in FIG. 13, the board member 90 is composed of an upper portion 93 and a lower portion 94 which includes notches 940 defined in an underside of the board member 90 so as to reinforce the structural strength of the board member 90. However, the notches 940 does not have extra feature other than reinforcement. FIG. 14 shows yet another board member 90 composed of an upper portion 95 and a lower portion 96. A plurality of ridges 950 on the upper portion 95 can does not provide better grasp feature.

When playing the skateboard, the players jump and flip the skateboard, and then grasp the periphery of the board member before grounding on floor. The conventional skateboards do not provide any grasp area allowing the plays to grasp the board member quickly and efficiently.

The present invention intends to provide a skateboard which includes different anti-slip areas located at different positions on the surfaces so that the players can easily grasp the skateboard.

### SUMMARY OF THE INVENTION

The present invention relates to a skateboard which comprises at least one layer of board member and a plurality of anti-slip portions are defined in an upper and bottom surfaces of the at least one layer of board member. The anti-slip portions are located close to a periphery of the at least one layer of board member and each anti-slip portion includes ridges and grooves.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a cross section of the skateboard of the present invention;

FIG. 2 is an exploded view to show the layers of board members of the present invention;

FIG. 3 shows a user grabs a first embodiment of the skateboard of the present invention;

FIG. 4 shows the cross sectional view of the skateboard which is grabbed by a user;

FIG. 5 shows a second embodiment of the skateboard of the present invention;

FIG. 6 shows a third embodiment of the skateboard of the present invention;

FIG. 7 shows a cross sectional view of the skateboard in FIG. 6;

FIG. 8 shows a fourth embodiment of the skateboard of the present invention;

FIG. 9 shows a fifth embodiment of the skateboard of the present invention;

FIG. 10 shows a cross sectional view of the skateboard in FIG. 9;

FIG. 11 shows a conventional skateboard;

FIG. 12 shows an end view of the conventional skateboard in FIG. 11;

FIG. 13 shows a cross sectional view of another conventional skateboard, and

FIG. 14 shows an end cross sectional view of the conventional skateboard in FIG. 13.

### DETAILED DESCRIPTION OF THE PREFERRED EMBODIMENT

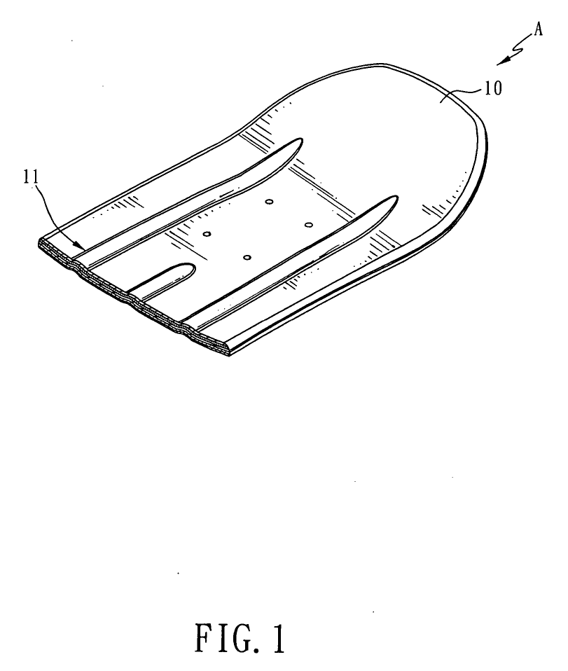

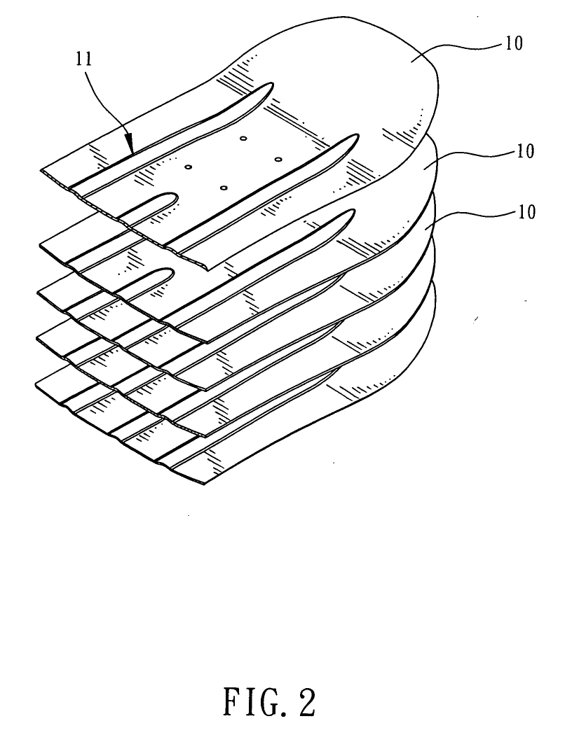

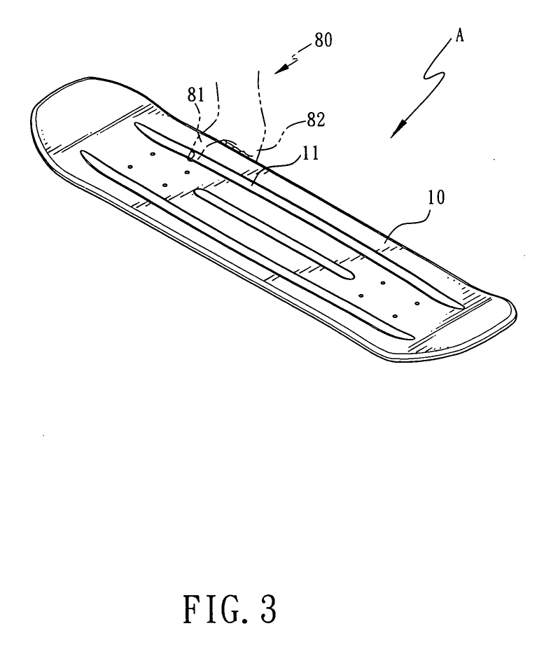

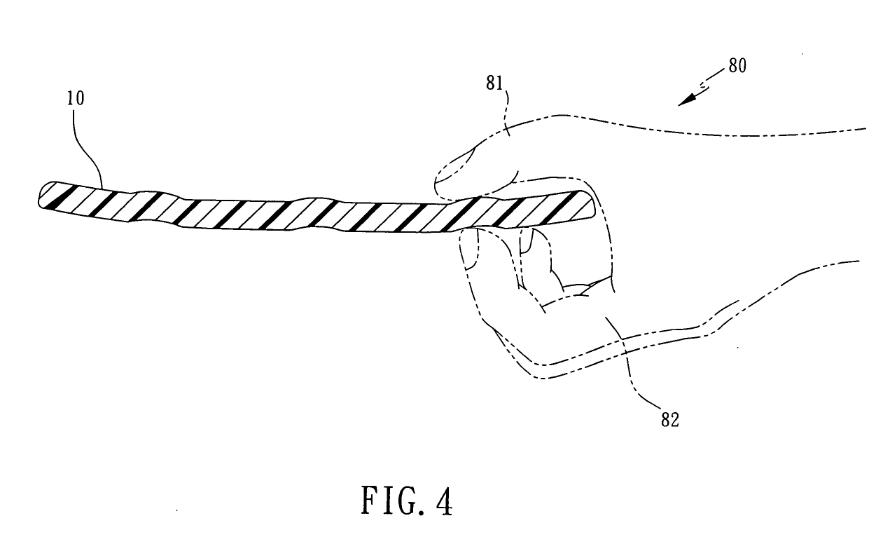

Referring to FIGS. 1 to 4, the skateboard “A” of the present invention comprises at least one layer of board member 10 and in this embodiment, the number of the layers of board members 10 is five and a plurality of anti-slip portions 11 such as three anti-slip portions are defined in an upper and bottom surfaces of each of the layers of board members 10. The multiple layers of board member 10 are connected with each other to form the skateboard “A”. Each anti-slip portion 11 includes ridges and grooves and the anti-slip portions 11 are located close to a periphery of the board member 10 so that the user 80 can easily grab the skateboard “A” from the periphery of the skateboard “A”.

The anti-slip portions 11 allow the thumb 81 and the rest fingers 82 of the user 80 to easily grab the upper and bottom surfaces after flipping the skateboard “A”. Besides, because each layer of the board member 10 includes the anti-slip portions 11 so that the structural strength of the skateboard “A” can be reinforced.

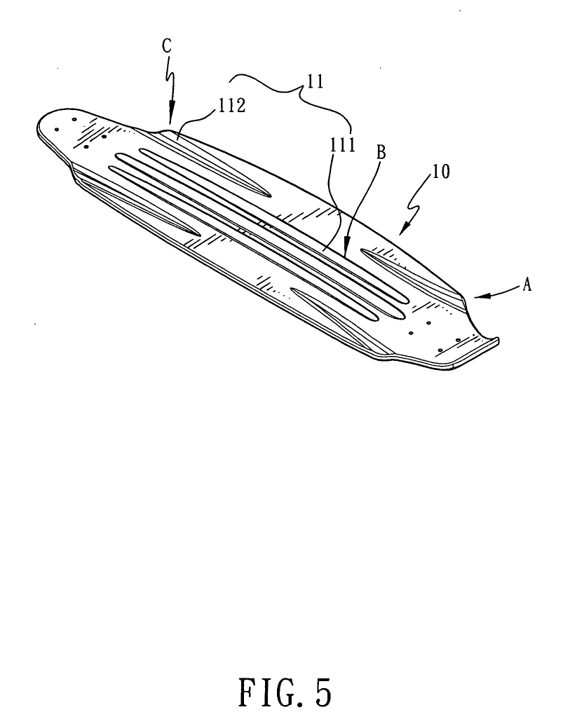

As shown in FIG. 5, the anti-slip portions 11 includes a first area “B” located at a central portion of each of the board members 10 and including three elongate anti-slip strips 111. A second area “C” is defined in each of four corners of the at least one layer of board member 10 and includes recessed and bending areas 112. The skateboard “A” is a linear board and includes a rounded front end and an upward bending rear end.

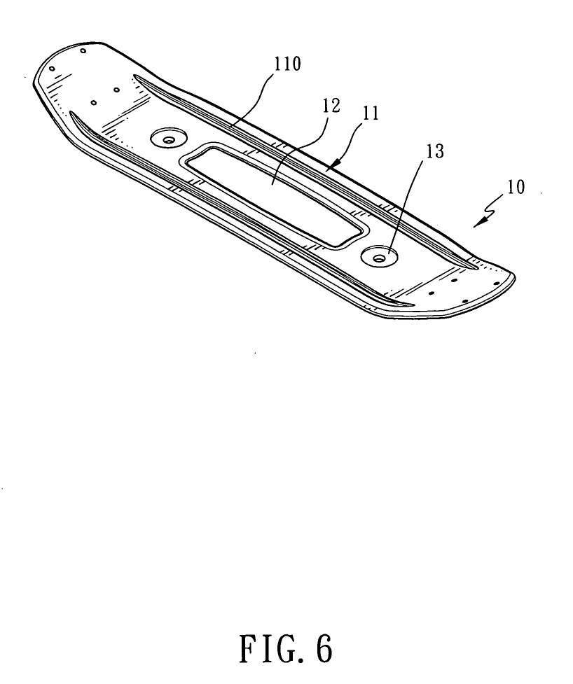

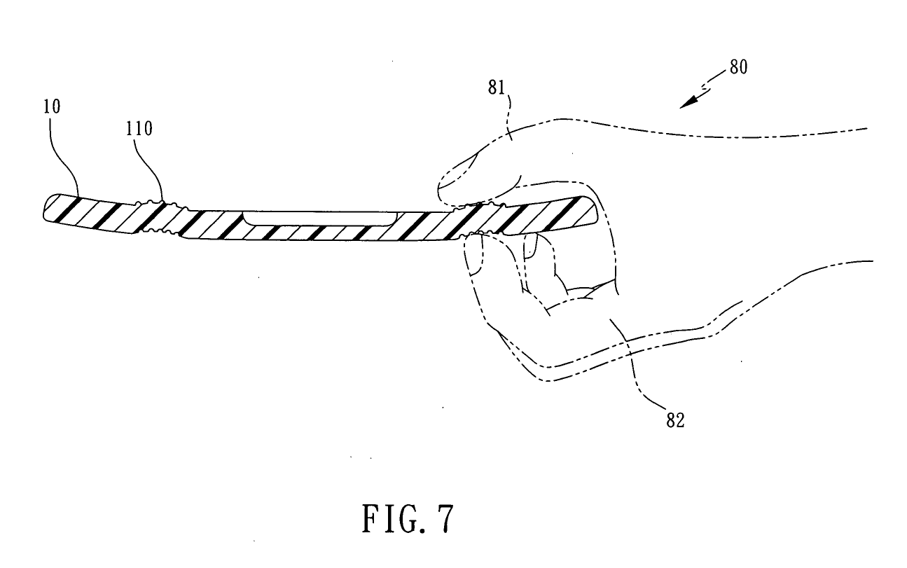

As shown in FIG. 6, the skateboard “A” includes two anti-slip portions 11 located at two sides of the skateboard “A”. A reinforcement area 12 is defined in a central portion of the skateboard “A” and two sub-reinforcement areas 13 each in a form of recessed circle are located at two ends of the reinforcement area 12. By the reinforcement area 12 and the two sub-reinforcement areas 13, the skateboard “A” has a strong structural strength. A through hole is defined through each of the sub-reinforcement areas 13 so as to be connected with other objects. Each anti-slip portion 11 includes elongate anti-slip strips 111. As shown in FIG. 7, parallel ridges and grooves are defined in surfaces of the elongate anti-slip strips 111 such that the user's thumb 81 and the rest fingers 82 can conveniently grab the skateboard “A”.

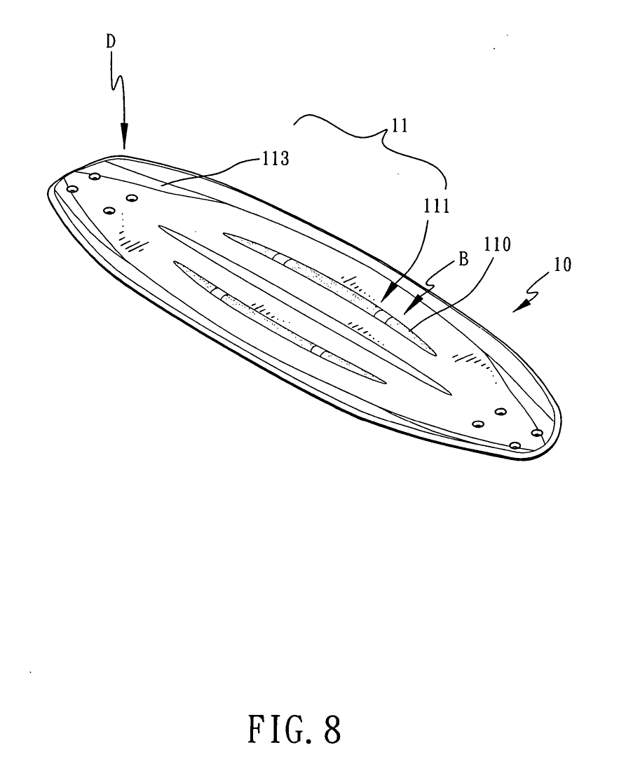

As shown in FIG. 8, the skateboard “A” is an oval board and has a first area “B” at a central portion thereof. The first area “B” has a plurality of elongate anti-slip strips 111 on two sides thereof and each anti-slip strip 111 has an anti-slip surface 110. The anti-slip surface 110 includes a plurality of tiny bosses and is composed of a plurality of sections so as to obtain an attractive outer appearance. Two third areas “D” are defined in two sides of the skateboard “A” and extend upward. Each third area “D” includes a plurality of bending areas 113 for convenience of grabbing and increasing its structural strength.

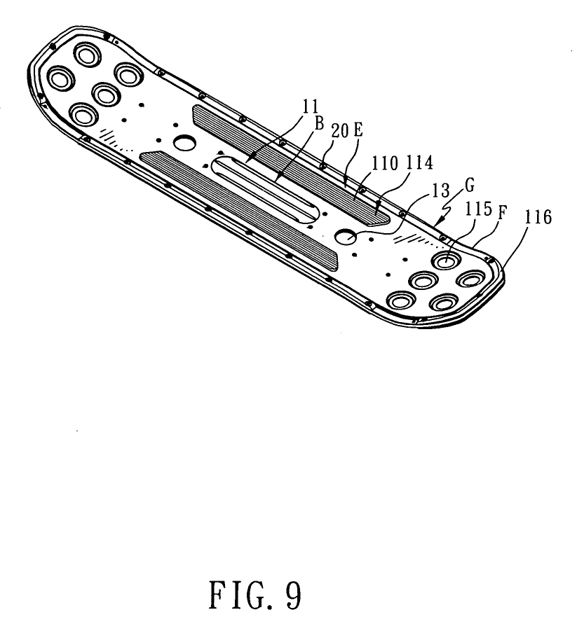

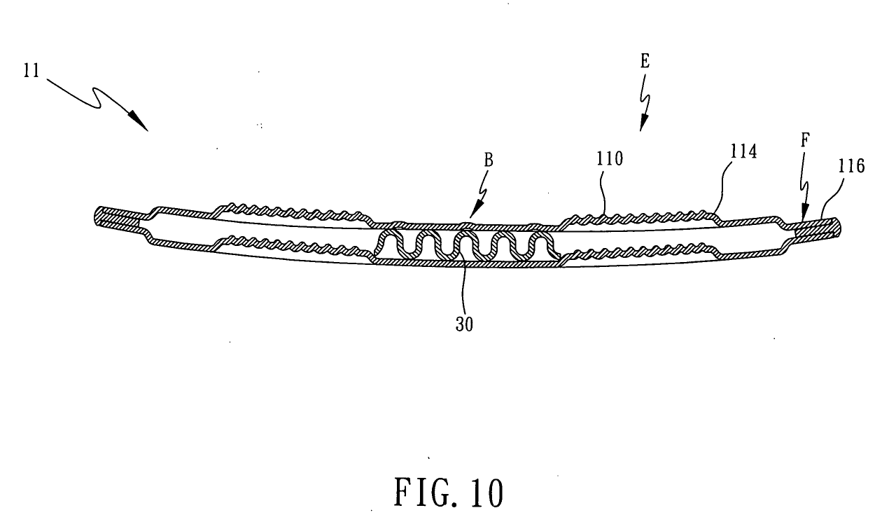

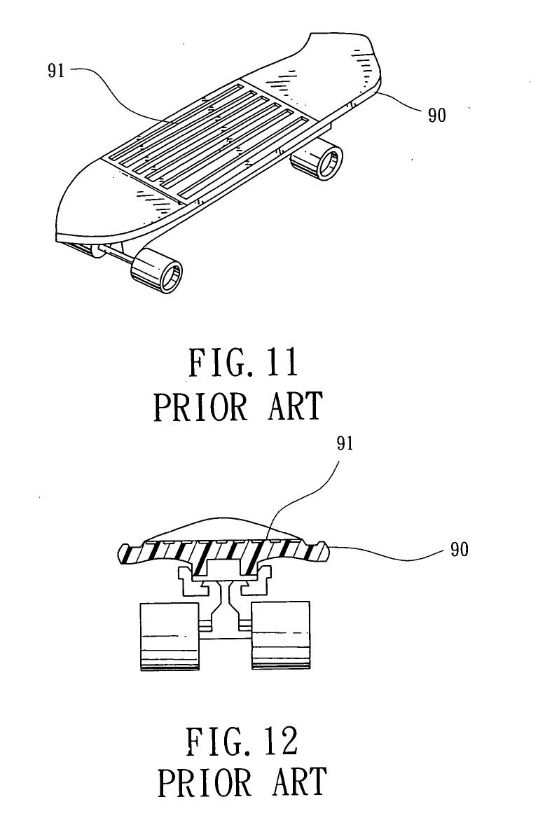

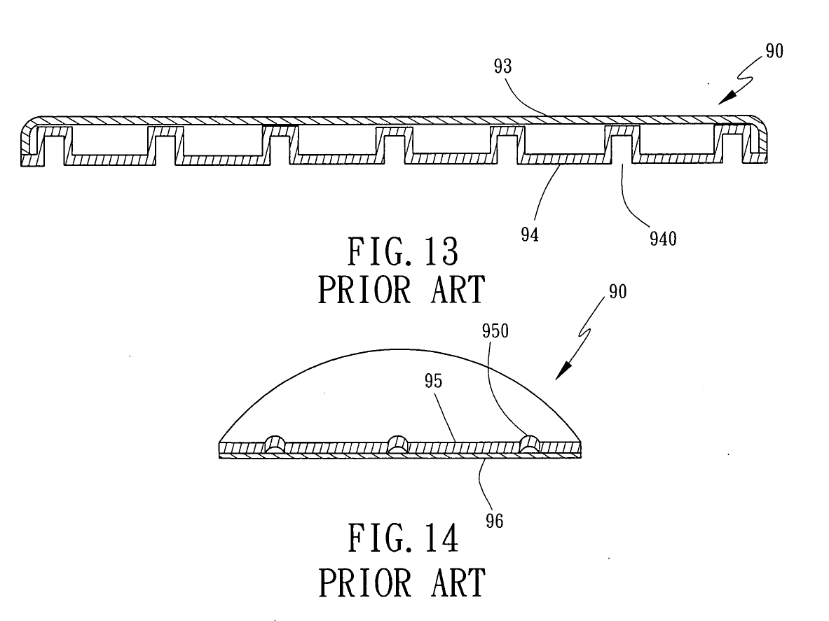

As shown in FIGS. 9 and 10, the anti-slip portion 11 may include a first area “B” located at a central portion of the skateboard “A” and has three elongate anti-slip strips 111. Two fourth areas “E” are located on two sides of the first area “B” and each fourth area “E” has a plurality of polygonal anti-slip strips 114. Each polygonal anti-slip strips 111 includes parallel ridges. Two fifth areas “F” are defined in two bent ends of the board member 10 and each fifth area “F” has a plurality of recesses 115 which include stepped inner peripheries. A sixth area “G” is defined in a periphery of the skateboard “A” and includes stepped portions 116. Each area may have anti-slip surfaces as needed.

The layers of board member 10 can be made by metal and are connected with each other by connection members 20 which can be rivets, bolts soldering agent, and connect two stepped portions 116 together such that the skateboard “A” includes two board members 10 and a reinforcement layer 30 is located between the two board members 10. The reinforcement layer 30 includes a wave-shaped structure. Two sub-reinforcement areas 13 each in a form of recessed circle are located at two ends of the reinforcement area 12 and a through hole is defined through each of the sub-reinforcement areas 13 so as to be connected with other objects.

While we have shown and described the embodiment in accordance with the present invention, it should be clear to those skilled in the art that further embodiments may be made without departing from the scope of the present invention.

1. A skateboard (A) comprising:
at least one layer of board member (10) and a plurality of anti-slip portions (11) defined in an upper and bottom surfaces of the at least one layer of board member (10), each anti-slip portion (11) including ridges and grooves, the anti-slip portions (11) located close to a periphery of the at least one layer of board member (10).

2. The skateboard as claimed in claim 1, wherein the anti-slip portions (11) includes a first area (B) located at a central portion of the at least one layer of board member (10) and including a plurality of elongate anti-slip strips (111), a second area (C) defined in each of four corners of the at least one layer of board member (10) and including recessed and bending areas (112), the at least one layer of board member (10) having a rounded front end and an upward bending rear end.

3. The skateboard as claimed in claim 1, wherein the anti-slip portions (11) include elongate anti-slip strips (111) and an reinforcement area (12) is defined in a central portion of the at least one layer of board member (10), two sub-reinforcement areas (13) located at two ends of the reinforcement area (12.

4. The skateboard as claimed in claim 1, wherein the at least one layer of board member (10) is an oval board and has a first area (B) at a central portion thereof, the first area (B) having a plurality of elongate anti-slip strips (111), two third areas (D) defined in two sides of the at least one layer of board member (10) and extending upward, each third area (D) includes a plurality of bending areas (113).

5. The skateboard as claimed in claim 1, wherein the anti-slip portions (11) of the at least one layer of board member (10) comprises a first area (B) located at a central portion of the at least one layer of board member (10) and having a plurality of elongate anti-slip strips (111), two fourth areas (E) on two sides of the first area (B) and each fourth area (E) having polygonal anti-slip strips (114), two fifth areas (F) defined in two bent ends of the board member (10 and each fifth area (F) having a plurality of recesses (115) which include stepped inner peripheries, a sixth area (G) defined in a periphery of the at least one layer of board member (10) and including stepped portions (116).

6. A skateboard (A) comprising:
a plurality layers of board members (10) and a reinforcement layer (30) located between the plurality layers of board members (10), a plurality of anti-slip portions (11) defined in an upper and bottom surfaces of the layers of board members (10).

7. The skateboard as claimed in claim 6, wherein the reinforcement layer (30) includes a wave-shaped structure.

8. The skateboard as claimed in claim 6, wherein the plurality layers of board members (10) are connected with each other by connection members (20).

9. A skateboard (A) comprising:
at least one layer of board member (10) and a plurality of anti-slip portions (11) defined in an upper and bottom surfaces of the at least one layer of board member (10), each anti-slip portion (11) including ridges and grooves and each ridge having an anti-slip surface (110), the anti-slip portions (11) located close to a periphery of the at least one layer of board member (10).

10. The skateboard as claimed in claim 9, wherein the anti-slip portions (11) includes a first area (B) located at a central portion of the at least one layer of board member (10) and including a plurality of elongate anti-slip strips (111), a second area (C) defined in each of four corners of the at least one layer of board member (10) and including recessed and bending areas (112), the at least one layer of board member (10) having a rounded front end and an upward bending rear end, each of the elongate anti-slip strips (111) having an anti-slip surface (110).

11. The skateboard as claimed in claim 9, wherein the anti-slip portions (11) include elongate anti-slip strips (111) and an reinforcement area (12) is defined in a central portion of the at least one layer of board member (10), two sub-reinforcement areas (13) located at two ends of the reinforcement area (12), the elongate anti-slip strips (111) each having an anti-slip surface (110).

12. The skateboard as claimed in claim 9, wherein the at least one layer of board member (10) is an oval board and has a first area (B) at a central portion thereof, the first area (B) having a plurality of elongate anti-slip strips (111), two third areas (D) defined in two sides of the at least one layer of board member (10) and extending upward, each third area (D) includes a plurality of bending areas (113), the elongate anti-slip strips (111) each having an anti-slip surface (110).

13. The skateboard as claimed in claim 9, wherein the anti-slip portions (11) of the at least one layer of board member (10) comprises a first area (B) located at a central portion of the at least one layer of board member (10) and having a plurality of elongate anti-slip strips (111), two fourth areas (E) on two sides of the first area (B) and each fourth area (E) having polygonal anti-slip strips (114), two fifth areas (F) defined in two bent ends of the board member (10) and each fifth area (F) having a plurality of recesses (115) which include stepped inner peripheries, a sixth area (G) defined in a periphery of the at least one layer of board member (10) and including stepped portions (116), the elongate anti-slip strips (111) each having an anti-slip surface (110).

14. The skateboard as claimed in claim 9, wherein the anti-slip surface (110) includes parallel ridges.

15. The skateboard as claimed in claim 9, wherein the anti-slip surface (110) includes a plurality of tiny bosses.

16. The skateboard as claimed in claim 9, wherein the anti-slip surface (110) is composed of a plurality of sections.
